(19) United States
(12) Patent Application Publication
(10) Pub. No.: US 2013/0143513 A1
(43) Pub. Date: Jun. 6, 2013

(54) User Accessible Multimedia Geospatial Routing Engine

(71) Applicants: Thomas Ginter, Bellevue, WA (US); Girish SIVARAM, Renton, WA (US); Firdaus ARYANA, Seattle, WA (US)

(72) Inventors: Thomas Ginter, Bellevue, WA (US); Girish SIVARAM, Renton, WA (US); Firdaus ARYANA, Seattle, WA (US)

(21) Appl. No.: 13/705,918

(22) Filed: Dec. 5, 2012

Related U.S. Application Data
(60) Provisional application No. 61/566,913, filed on Dec. 5, 2011.

(51) Int. Cl. H04W 12/02

(52) U.S. Cl. CPC H04W 12/02
USPC 455/404.1

(57) ABSTRACT

A method and apparatus to facilitate the secure storage of multimedia content (i.e. video with optional audio) on an internet cloud, and to grant the release of stored multimedia content to pre-authorized users and pre-authorized emergency dispatch personnel, only. A subscriber entity uses a secure user interface component to store a multimedia package containing important/relevant navigation and/or location information on a cloud database. In addition, the subscriber entity specifies whether or not emergency personnel are authorized to access the multimedia package during an emergency event, and whether or not a predefined highly trusted network of users may access the multimedia package following a conventional authorization procedure. The inventive multimedia geospatial routing engine releases the multimedia package to members of a subscriber's highly trusted network of users, by pre-authorization only, and to emergency dispatch personnel subscribed to the subscriber multimedia content database, in the case of an emergency event only.

The present application claims priority from U.S. Provisional No. 61/566,913, entitled “User Accessible Multimedia Geospatial Routing Engine” to Ginter et al., the entirety of which is explicitly incorporated herein by reference.

### BACKGROUND OF THE INVENTION

1. Field of the Invention

This invention relates generally to telecommunications. More particularly, it relates to location services and public safety.

2. Background of Related Art

Individuals unfamiliar with an area/location may experience difficulty when attempting to navigate that particular area/location. Fortunately, conventional mapping (e.g. Mapquest, Google Maps, etc.) and navigation (e.g. GPS) services provide route instructions to users, to enable users to travel routes with which they are unfamiliar.

In particular, conventional mapping services (e.g. Mapquest, Google Maps, etc.) and conventional navigation services (e.g. GPS) generate route instructions between a given point A location and a given point B location, when both point A and point B locations are one of a civic address, a landmark, a business, a point of interest, a geographic area (e.g. a town, a city, a state, etc.), a historic site, or any other location maintained in a relevant mapping database. For example, a user may employ a conventional mapping service and/or a conventional navigation service to generate route instructions between a home address (i.e. a civic address) and a college campus (i.e. a place of business), and/or between a college campus and a local fast food restaurant (i.e. a point of interest).

However, conventional mapping services (e.g. MapQuest, Google Maps, etc.) and conventional navigation services (e.g. GPS) are not capable of generating route instructions between a given point A location and a given point B location, when point A and/or point B locations are one of an indoor location, an on-site location, or any other location for which civic address route instructions may not be generated. For instance, a user may not employ a conventional mapping service and/or a conventional navigation service to generate route instructions to a specific room in a campus library (i.e. an indoor location). Moreover, a user may not employ a conventional mapping service and/or a conventional navigation service to generate route instructions between a campus dorm room (i.e. an on-site location) and a campus cafeteria (i.e. an on-site location).

However, certain existing technological services do provide limited indoor/on-site location information to users. For instance, existing application, Point Inside, for which additional information may be found at http://www.pointinside.com, provides one-dimensional indoor maps and on-site location layouts of supported venues to users. Indoor maps and on-site location layouts provided by Point Inside, enable users to locate specific shops, facilities (e.g., ATMs, restrooms, and elevators/stairs), and areas of interest within venues supported by the application. Point Inside additionally employs micro-location and indoor mapping technologies, to enable a user to seamlessly travel from a current location to a location of a desired shop/facility/area within a supported venue. Unfortunately, location information provided by Point Inside only pertains to individual venues. Hence, inter-venue navigation information is not available.

Currently, route instructions are provided to users via the following information medium: text (e.g. online text instructions, short message service text instructions, etc.), voice (e.g. a voice call), and interactive user maps (e.g. driving directions provided by a conventional navigation system). For instance, existing application, Point Inside, provides map-based location information to users. Moreover, conventional mapping and navigation services provide a combination of voice, text, and map-based location information to users. However, these information medium are technologically very restrictive in terms of providing relevant location information to users.

There are, however, certain existing technological services that use multimedia content to furnish basic navigation and location information to users. For example, existing application, Real Places, for which additional information may be found at http://realplaces/Home.php, enables a user to upload and share interactive walkarounds of a particular venue, area, location, etc., of interest. Real Places uses intelligently-linked sets of subscriber-uploaded still images to portray general and specific views of a given location.

Existing technological services do not provide rich multimedia content detailing relevant location and/or navigation information to emergency dispatch services (e.g. public safety answering points.

### SUMMARY OF THE INVENTION

A method and apparatus to facilitate the secure storage of multimedia packages on an internet cloud, and to permit the release of stored multimedia packages to pre-authorized users and pre-authorized emergency dispatch personnel only, comprises a multimedia geospatial routing engine and a secure user interface component. A multimedia package, in accordance with the principles of the present invention, comprises a video file with an optional audio track.

In accordance with the principles of the present invention, a subscriber entity uses a secure user interface component to provision basic identification credentials (e.g. a name, address, mobile directory number associated with a relevant subscriber device, etc.), unique authorization credentials (e.g. a username/password combination, an MSISDN, a cloud database ID, etc., for pre-authorization purposes), and a highly trusted network of users in to a subscriber profile, during an initial account subscription process. A subscriber profile provisioned for a given subscriber entity is then stored in a subscriber multimedia content database and maintained on an internet cloud (i.e. an internet based cloud location).

In accordance with the principles of the present invention, a subscriber entity provisions multimedia packages containing important/relevant navigation and/or location information in to a subscriber profile, via a secure user interface component. To successfully store a multimedia package, a subscriber entity must specify whether a predefined highly trusted network of users is permitted to access the given multimedia package (i.e. pre-authorized to access the multimedia package), and whether or not emergency dispatch personnel are permitted access to the multimedia package (i.e. pre-authorized to access the multimedia package) during an emergency event (e.g. a 911 call).

In accordance with the principles of the present invention, an emergency dispatch service (e.g. a public safety answering point (PSAP)) may subscribe to the inventive subscriber multimedia content database, to gain access to multimedia content identified for emergency services.

In accordance with the principles of the present invention, a multimedia geospatial routing engine prompts a user desiring to access/upload multimedia content to/from the inventive subscriber multimedia content database, to first perform a user pre-authorization procedure. The multimedia geospatial routing engine requires that a subscriber entity successfully complete a user pre-authorization procedure (e.g. a conventional user login procedure), before permitting that subscriber entity to access authorized video content, and/or before permitting that subscriber entity to upload new video content.

Moreover, the inventive multimedia geospatial routing engine accepts requests for stored multimedia content from emergency dispatch personnel (e.g. public safety answering points) subscribed to the inventive subscriber multimedia content database. In accordance with the principles of the present invention, the multimedia geospatial routing engine responds to multimedia content requests received from emergency dispatch personnel (e.g. public safety answering point) during emergency call processing, with stored multimedia packages that are both authorized to be released to emergency dispatch personnel, and relevant to an initiated emergency event.

The inventive multimedia geospatial routing engine releases multimedia packages to members of a subscriber entity's highly trusted network of users by pre-authorization only, and to emergency dispatch personnel subscribed to the subscriber multimedia content database, in the case of an emergency event only. The present invention provides rich multimedia content to emergency dispatch services.

In accordance with the principles of the present invention, stored multimedia packages may be released to pre-authorized users and/or pre-authorized emergency dispatch personnel on a time-sensitive basis.

### BRIEF DESCRIPTION OF THE DRAWINGS

Features and advantages of the present invention become apparent to those skilled in the art from the following description with reference to the drawings:

FIG. 1 depicts an exemplary network structure for storing multimedia packages for release to pre-authorized users and pre-authorized emergency dispatch personnel only, in accordance with the principles of the present invention.

FIG. 2 depicts an exemplary process of storing and releasing multimedia packages containing important/relevant navigation and/or location information to pre-authorized users and/or pre-authorized emergency dispatch personnel only, in accordance with the principles of the present invention.

FIG. 3 depicts a process flow portraying exemplary release of stored multimedia packages to pre-authorized users and pre-authorized emergency dispatch personnel, in accordance with the principles of the present invention.

FIG. 4 depicts an exemplary record stored in a subscriber multimedia content database, in accordance with the principles of the present invention.

### DETAILED DESCRIPTION OF ILLUSTRATIVE EMBODIMENTS

The present invention stores multimedia packages containing important/relevant navigation and/or location information in a subscriber multimedia content database, and subsequently releases stored multimedia packages to pre-authorized users, and pre-authorized emergency dispatch personnel (e.g. public safety answering points (PSAPS)), only. A multimedia package, in accordance with the principles of the present invention, comprises a video file and an optional audio track.

In accordance with the principles of the present invention, a video (with optional audio) detailing important/relevant navigation and/or location information is stored in a cloud database and only released to members of a highly trusted network of users following a successful authorization procedure, and/or to pre-authorized emergency dispatch personnel, upon initiation of a relevant emergency event.

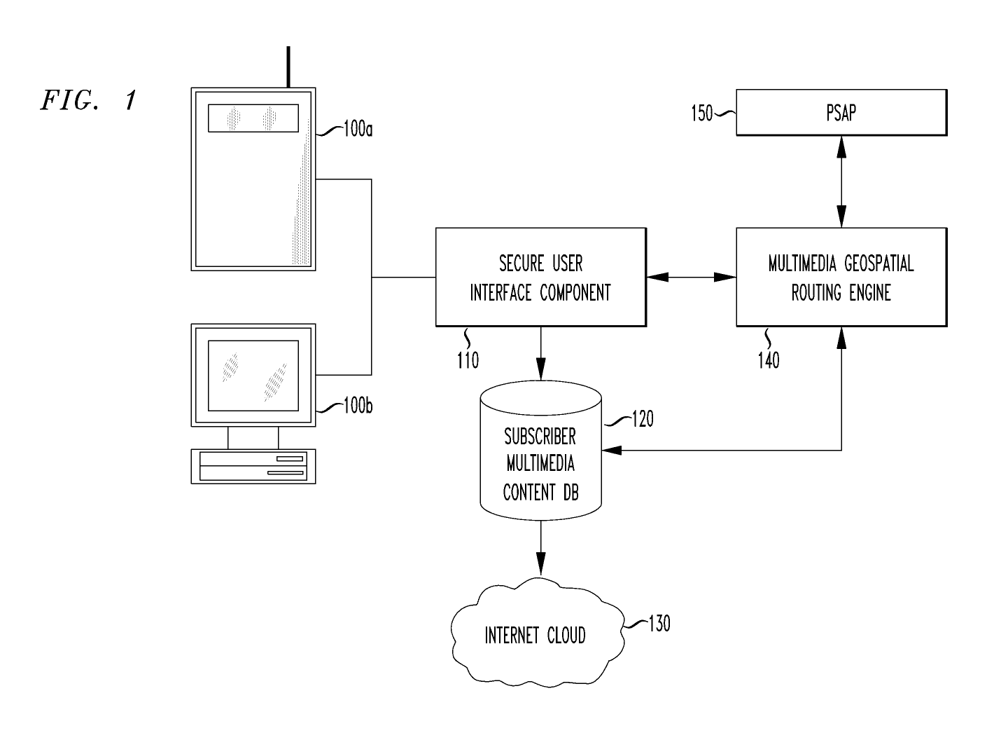

FIG. 1 depicts an exemplary network structure for storing multimedia packages for release to pre-authorized users and/or pre-authorized emergency dispatch personnel only, in accordance with the principles of the present invention.

In particular, as depicted in FIG. 1, multimedia packages comprising important/relevant navigation and/or location information are stored in a subscriber multimedia content database 120, via a secure user interface component 110. In particular, a subscriber entity accesses a secure user interface component 110 via one of a number of devices 100 (e.g. a smart 100a, a personal computer 100b, etc.), to provision multimedia content and subscriber account information in to a subscriber profile. Subscriber account information maintained in a subscriber profile preferably comprises: subscriber identification credentials (e.g. name, address, mobile directory number of an associated subscriber device), subscriber authorization credentials (e.g. a username/password combination, an MSISDN, a cloud database ID, etc.), and a highly trusted network of users. As depicted in FIG. 1, a subscriber profile provisioned for a given subscriber entity is stored in a subscriber multimedia content database 120, and maintained on an internet cloud (i.e. an internet based cloud location) 130.

In accordance with the principles of the present invention, an emergency dispatch service (e.g. a public safety answering point (PSAP)) 150 may subscribe to the inventive subscriber multimedia content database 110, to gain access to stored multimedia packages identified for emergency services.

As portrayed in FIG. 1, stored multimedia packages are released to pre-authorized users and pre-authorized emergency dispatch personnel 150, only, via a multimedia geospatial routing engine 140. In accordance with the principles of the present invention, the inventive multimedia geospatial routing engine releases multimedia packages to members of a subscriber entity's highly trusted network of users, following pre-authorization only. Hence, the inventive multimedia geospatial routing engine 140 requires subscribers to successfully complete a pre-authorization procedure (e.g. a conventional user login procedure), before permitting those subscribers to gain access to multimedia content stored in the inventive subscriber multimedia content database 120.

In accordance with the principles of the present invention, the inventive multimedia geospatial routing engine 140 accepts requests for stored multimedia content from emergency dispatch personnel (e.g. a public safety answering point) 150 subscribed to the inventive subscriber multimedia content database 120. In accordance with the principles of the present invention, the multimedia geospatial routing engine 140 responds to multimedia content requests received from emergency dispatch personnel (e.g. public safety answering point) 150, with stored multimedia packages that are both authorized to be released to emergency dispatch services 150, and relevant to an initiated emergency event.

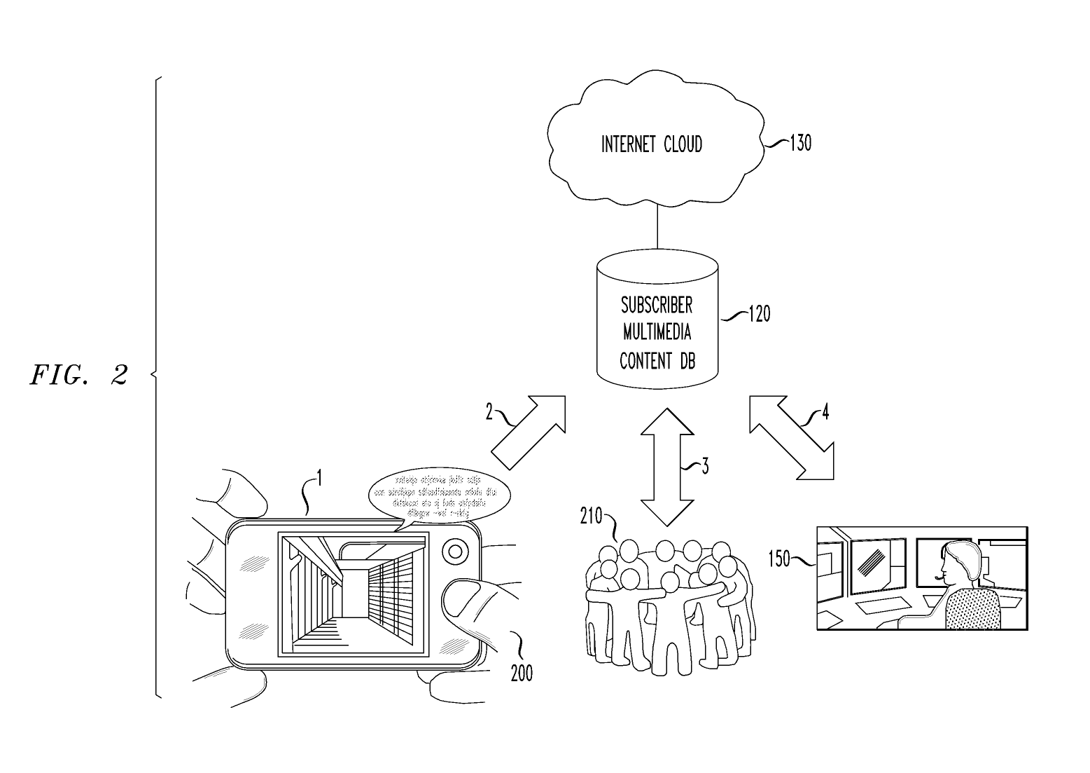

FIG. 2 depicts an exemplary process of storing and releasing multimedia packages containing important/relevant navigation and/or location information to pre-authorized users and/or pre-authorized emergency dispatch personnel only, in accordance with the principles of the present invention.

In particular, a subscriber first records a video (with an optional audio track) (e.g. walkpath.mpg) 200 detailing walking directions from a point A location to a point B location, as shown in step 1. The subscriber then uploads the recorded multimedia package (e.g. walkpath.mpg) 200 to a subscriber multimedia content database 120 maintained on an internet cloud 130, as shown in step 2. In step 3, the multimedia geospatial routing engine 140 releases the stored multimedia package (e.g. walkpath.mpg) 200 to all users 210 pre-authorized to access the video 200. In step 4, the multimedia geospatial routing enaine 140 releases the stored multimedia package (e.g. walkpath.mpg) 200 to emergency dispatch personnel (e.g. Public Safety Answering Points (PSAPs)) 150 authorized to access the uploaded multimedia package 200, upon initiation of a relevant emergency event (e.g. a 911 call).

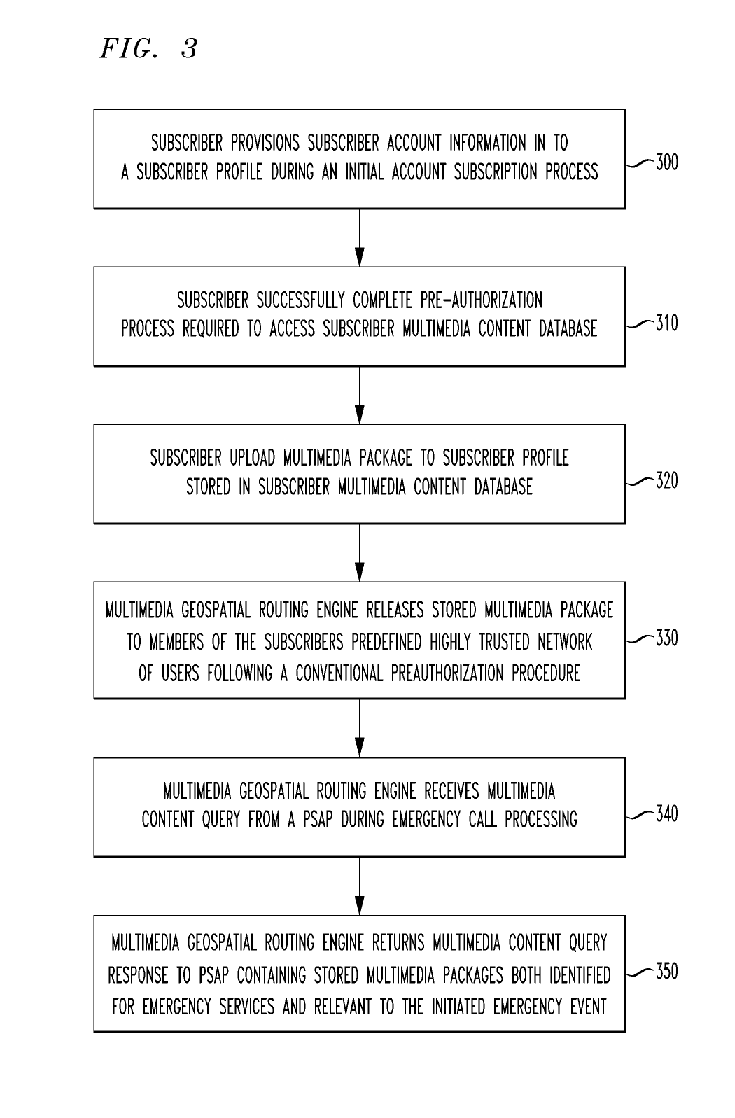

FIG. 3 depicts a process flow portraying exemplary release of stored multimedia packages to pre-authorized users and pre-authorized emergency dispatch personnel, in accordance with the principles of the present invention.

In particular, during an initial account subscription process, a user is prompted to provision basic identification credentials (e.g. name, address, mobile directory number of the user's mobile device, etc.), unique authorization credentials (e.g. a username/password combination, an MSISDN, a cloud database ID, etc., for pre-authorization purposes), and a highly trusted network of users 210 in to a subscriber profile, via a secure user interface component 110, as depicted in step 300 of FIG. 3. The subscriber profile provisioned for the given subscriber entity is then stored in an inventive subscriber multimedia content database 120, and maintained on an internet cloud 130.

In accordance with the principles of the present invention, the subscriber entity uses unique authorization credentials (e.g., a username/password combination, a MSISDN, a cloud database ID, etc.) provisioned during the initial account subscription process, to gain access to stored multimedia content. Moreover, the highly trusted network of users 210 defined in the subscriber profile provisioned for the given subscriber entity, represents a set of users that the subscriber entity may (or may not) authorize (as a collective unit) to access multimedia packages stored thereby.

As depicted in step 310 of FIG. 3 the subscriber entity successfully completes a user pre-authorization procedure, following initial account subscription, to gain access to the inventive subscriber multimedia content database 120.

In step 320 of FIG. 3, the subscriber entity uses the secure user interface component 110 to store a multimedia package containing navigation and/or location information in the subscriber multimedia content database 120, for subsequent release to pre-authorized users 210 and pre-authorized emergency dispatch personnel 150, only.

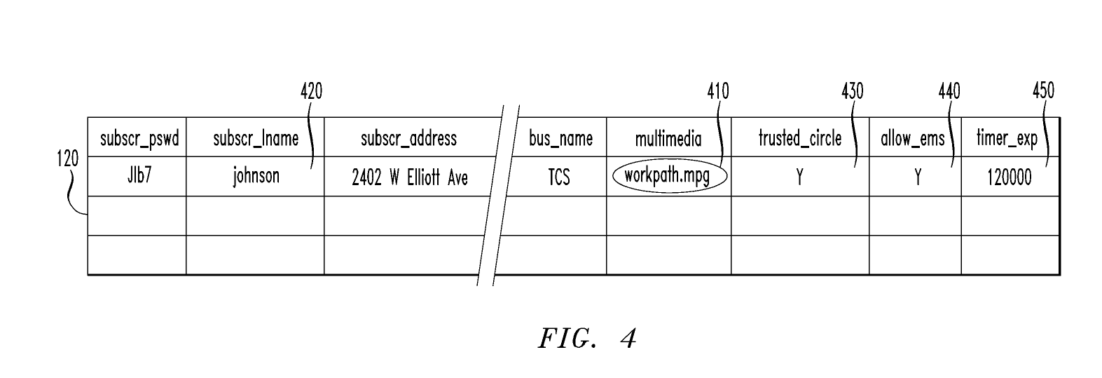

FIG. 4 depicts an exemplary record stored in a subscriber multimedia content database, in accordance with the principles of the present invention.

In particular, to successfully store a multimedia package (e.g. workpath.mpg) 410 in the inventive subscriber multimedia content database 120, the subscriber 420 must first: specify whether or not the subscriber's 420 predetermined highly trusted network of users 210 is permitted to access the given multimedia package 430, and additionally, either grant or deny authorization permitting emergency dispatch personnel (e.g. Public Safety Answering Points (PSAPs)) 150 to access the multimedia package during an emergency event (e.g. when a 911 call is initiated) 440.

As depicted in FIG. 4, a subscriber entity 420 may also identify a time expiry value 450 for the stored multimedia package (e.g. workpath.mpg). In particular, requested database information may be released to subscribers on a time-sensitive basis. For example, a user may be able to access a video containing a detailed layout of a military base for one day only, or for a few hours only, etc.

In accordance with the principles of the present invention, the subscriber entity may also optionally tag the multimedia package with a descriptive location identifier, e.g., an address, general location, POI, place of business, etc., with which the multimedia package may then be associated. Video tags merely provide authorized users 210/emergency dispatch personnel 150 with descriptive information about a video. Video tags are not searchable and are only available to pre-authorized users, not to the public.

As depicted in step 330 of FIG. 3, the inventive multimedia geospatial routing engine 140 then releases the stored multimedia package to members of the subscriber's predefined highly trusted network of users 210, following a conventional pre-authorization procedure (e.g. a conventional login procedure).

In step 340, the multimedia geospatial routing engine receives a multimedia content request from an authorized public safety answering point (i.e. a public safety answering point subscriber to the subscriber multimedia content database) 150, requesting multimedia packages containing navigation/location information relevant to an initiated emergency event.

In accordance with the principles of the present invention, all multimedia objects identified for emergency dispatch services 150, are available to emergency dispatch personnel (e.g. PSAPs) 150 subscribed to the subscriber multimedia content database 120, by default, hence no pre-authorization is required. However, a public safety answering point (PSAP) 150 is required to subscribe to the multimedia navigation and location information database 120 to gain full access to database content. Once a public safety answering point (PSAP) 150 subscribes to the cloud database, that public safety answering point (PSAP) 150 is considered a trusted entity in the call flow.

As portrayed in step 350 of FIG. 3, the multimedia geospatial routing engine 140 returns a multimedia content response to the requesting public safety answering point (PSAP) 150, containing multimedia packages that are both identified for emergency services, and relevant to the initiated emergency event. For instance, the multimedia geospatial routing engine 140 may return multimedia packages to the requesting public safety answering point (PSAP) 150, containing, e.g., location/navigation information pertaining to the location emergency services were requested in. Moreover, the multimedia geospatial routing engine may additionally/alternatively return, e.g., multimedia packages stored in the subscriber multimedia content database by the subscriber entity that initiated the emergency event.

In addition, information regarding hazardous materials (HAZMAT) present at a given location may be released to emergency dispatch personnel (e.g. a Public Safety Answering Point (PSAP)) 150 when an emergency event is initiated at that particular location (e.g. when a 911 call is initiated at that particular location). Enabling hazardous materials (HAZMAT) information to be released to emergency dispatch personnel 150 in the event of an emergency, may potentially provide valuable, life-saving information to emergency first responders 150.

The inventive multimedia geospatial routing engine 140 releases multimedia packages to members of a subscriber entity's highly trusted network of users, by pre-authorization only, and to emergency dispatch personnel 150 subscribed to the subscriber multimedia content database, in the case of an emergency event only. The present invention provides rich multimedia content to emergency dispatch personnel 150.

A subscriber may use the present invention to upload videos containing detailed navigation information (e.g., detailed walking directions from the front of a subscriber's apartment building to that subscriber's actual apartment within the apartment building), for release to emergency dispatch services 150 and close friends and family 210 in the event of an emergency.

A subscriber's stored location data is available to other subscribers by pre-authorization only. Moreover, a subscriber's stored location data is available to emergency dispatch services (e.g. public safety answering points (PSAPs)) 150, only if emergency dispatch services 150 have subscribed to the cloud database 120, and only in the case of an emergency.

A cloud database is able to leverage a great deal from new technologies available on today's “always connected” devices.

The present invention relates to the concept of breadcrumbing. Breadcrumbing is a known term used to describe an act of using an audio-visual multimedia package to guide users from a point A location to a point B location, when the route between point A and point B locations comprises an indoor location scenario, and/or a lack of civic address route instructions.

The present invention additionally relates to a concept of dynamically releasing one or more multimedia packages to a consumer, based on a user pre-authorization process, a predetermined event, and/or a time sensitive expiry method.

The principles of the present invention may be extended to enable a subscriber multimedia content database 120 to store publically available multimedia packages. In this particular embodiment, a subscriber may authorize all users to access a stored multimedia package, by defining a highly trusted network of users 210 to be ‘public’. A user may desire to define a stored multimedia package as ‘public’ for, e.g., enterprise use (e.g. route instructions for a college campus may be defined as public, to permit students applying for admission to the college to examine the college campus).

In this particular extended embodiment, multimedia packages available to the public may be searchable by, e.g. a subscriber name and/or a descriptive location identifier. Subscribers may also compile personalized route information in to a subscriber location profile and/or bookmark desired multimedia packages/data files, for retrieval upon future request.

Moreover, the present invention may also be extended to include storage of: text information for navigation/direction purposes, universal resource locators (URLs), metadata information, links to addresses, map data, RSS feeds, phone directory, etc.

The present invention has particular applicability to public safety answering points (PSAPs), first responders, commercial consumers, and/or enterprise access consumers.

While the invention has been described with reference to the exemplary embodiments thereof, those skilled in the art will be able to make various modifications to the described embodiments of the invention without departing from the true spirit and scope of the invention.

What is claimed is:

1. A secure user interface component to enable storage of subscriber information for subsequent release to pre-authorized user devices and pre-authorized emergency dispatch personnel only, wherein said subscriber information comprises:
multimedia packages; and
a highly trusted network of authorized user devices that may be authorized to access said multimedia packages.

2. A secure user interface component to enable storage of subscriber information for subsequent release to pre-authorized user devices and pre-authorized emergency dispatch personnel only according to claim 1, wherein said multimedia packages comprise:
video with optional audio.

3. A secure user interface component to enable storage of subscriber information for subsequent release to pre-authorized user devices and pre-authorized emergency dispatch personnel only according to claim 1, wherein:
at least one of said multimedia packages is sent to said highly trusted network of authorized user devices based on a pre-authorization process.

4. A secure user interface component to enable storage of subscriber information for subsequent release to pre-authorized user devices and pre-authorized emergency dispatch personnel only according to claim 1, wherein:
said multimedia packages are stored in a cloud database.

5. A secure user interface component to enable storage of subscriber information for subsequent release to pre-authorized user devices and pre-authorized emergency dispatch personnel only according to claim 3, wherein:
emergency dispatch services may subscribe to said cloud database to gain access to multimedia packages identified for emergency services.

6. A secure user interface component to enable storage of subscriber information for subsequent release to pre-authorized user devices and pre-authorized emergency dispatch personnel only according to claim 5, wherein:
at least one of said multimedia packages is sent to said emergency dispatch services subscribed to said cloud database based on an emergency event.

7. A multimedia geospatial routing engine to transmit a multimedia package to pre-authorized user devices and pre-authorized emergency dispatch personnel only, wherein:
said multimedia geospatial routing engine transmits said multimedia package to a respected at least one of a predefined highly trusted network of authorized user devices based on a pre-authorization process.

8. A multimedia geospatial routing engine to transmit a stored multimedia package to pre-authorized user devices and pre-authorized emergency dispatch personnel only according to claim 7, wherein:
said multimedia geospatial routing engine accepts a request for a multimedia package from said pre-authorized emergency dispatch personnel during emergency event processing.

9. A multimedia geospatial routing engine to transmit a stored multimedia package to pre-authorized users and pre-authorized emergency dispatch personnel only according to claim 8, wherein:
said multimedia geospatial routing engine responds to said request for said multimedia package from said pre-authorized emergency dispatch personnel with a pre-authorized and relevant multimedia package that is both pre-authorized to be transmitted to emergency dispatch services and relevant to an initiated emergency event.

10. A method of releasing a stored multimedia package to pre-authorized user devices and pre-authorized emergency dispatch personnel only, comprising:
storing a multimedia package received from a subscriber device in a cloud database;
releasing said multimedia package to a highly trusted network user device following a pre-authorization procedure;
accepting a request for said stored multimedia package from emergency dispatch personnel subscribed to said cloud database; and
releasing said multimedia packages, identified for emergency services and relevant to an initiated emergency event, to said emergency dispatch personnel subscribed to said cloud database in response to said request for said stored multimedia package.
